(19) United States
(12) Patent Application Publication
(10) Pub. No.: US 2026/0110199 A1
(43) Pub. Date: Apr. 23, 2026

(54) DOUBLE PAWL SYSTEM FOR VEHICLE DOOR LATCH

(71) Applicant: Inteva Products, LLC, Troy, MI (US)

(72) Inventor: Yoshihiko Tametani, Tokyo (JP)

(21) Appl. No.: 19/365,414

(22) Filed: Oct. 22, 2025

Related U.S. Application Data
(60) Provisional application No. 63/710,579, filed on Oct. 22, 2024.

(51) Int. Cl. E05B 85/24; E05B 81/14; E05B 81/34

(52) U.S. Cl. CPC E05B 85/24; E05B 81/14; E05B 81/34

(57) ABSTRACT

A latching system for a vehicle latch, including: a claw for retaining a striker in a primary position of the claw and a secondary position of the claw, the claw configured for movement about a claw pivot between at least the primary position and the secondary position; a primary pawl configured for movement about a primary pawl pivot between an engaged position and a disengaged position; and a secondary pawl configured for movement about a secondary pawl pivot between an engaged position and a disengaged position, the primary pawl and the secondary pawl retaining the claw in the primary position or the secondary position when the primary pawl is in the engaged position and the secondary pawl is in the engaged position; a disengagement lever configured for movement about a disengagement lever pivot, the disengagement lever being operatively coupled to the secondary pawl, wherein when the secondary pawl is in the disengaged position the claw is free to rotate into the primary position from the secondary position and the claw contacts the disengagement lever to maintain the secondary pawl in the disengaged position as the claw rotates into the primary position from the secondary position.

### CROSS REFERENCE TO RELATED APPLICATIONS

The present application claims the benefit of U.S. Provisional Patent Application No. 63/710,579 filed on Oct. 22, 2024, the contents of which are incorporated herein by reference thereto.

### BACKGROUND

Exemplary embodiments of the present disclosure pertain to the art of vehicle latches.

Conventional latch systems use a forkbolt or claw rotating about a fixed pivot and detent or pawl rotating about a fixed pivot to retain a moveable striker. The vast majority of latch systems retain the striker in two discreet positions with some amount of linear separation. In the instance of a large applied force to the striker with the conventional latch system, it may not be possible to rotate the detent or pawl out of engagement from the forkbolt or claw, preventing the latch from releasing the striker.

An alternative latch system design consists of a forkbolt or claw rotating about a fixed pivot, a primary detent or pawl rotating about a fixed pivot, and a secondary detent or pawl rotating about a fixed pivot. In this alternative design, the primary detent or pawl is biased such that it will tend to auto-disengage from the forkbolt or claw once the secondary detent or pawl is moved out of engagement from the primary detent or pawl. The alternative design requires significantly less energy to release a high load applied to the striker. However, the heretofore described alternative design is not typically able to move from the second striker position to first striker position during the latch closing operation.

One solution for this problem is a latch system that only uses the primary detent or pawl-secondary detent or pawl system to retain the forkbolt or claw in the first striker position. A separate detent or pawl lever is then used to retain the forkbolt or claw in the second striker position. This solution is not optimal as it requires additional components and manufacturing steps.

Accordingly, it is desirable to improve the operation of a vehicle latch with a double pawl retention system.

### BRIEF DESCRIPTION

Disclosed is a latching system for a vehicle latch, including: a claw for retaining a striker in a primary position of the claw and a secondary position of the claw, the claw configured for movement about a claw pivot between at least the primary position and the secondary position; a primary pawl configured for movement about a primary pawl pivot between an engaged position and a disengaged position; and a secondary pawl configured for movement about a secondary pawl pivot between an engaged position and a disengaged position, the primary pawl and the secondary pawl retaining the claw in the primary position or the secondary position when the primary pawl is in the engaged position and the secondary pawl is in the engaged position; a disengagement lever configured for movement about a disengagement lever pivot, the disengagement lever being operatively coupled to the secondary pawl, wherein when the secondary pawl is in the disengaged position the claw is free to rotate into the primary position from the secondary position and the claw contacts the disengagement lever to maintain the secondary pawl in the disengaged position as the claw rotates into the primary position from the secondary position.

In addition to one or more of the features described above, or as an alternative to any of the foregoing embodiments, the claw pivot, the primary pawl pivot, the secondary pawl pivot, and the disengagement lever pivot are fixedly secured to a frame such that the claw, the primary pawl, the secondary pawl, and the disengagement lever can rotate or pivot with respect to the frame.

In addition to one or more of the features described above, or as an alternative to any of the foregoing embodiments, the latching system further including: a primary pawl lifter rotationally mounted to the primary pawl pivot, wherein movement of the primary pawl lifter about the primary pawl pivot will also cause a corresponding movement of the primary pawl; and a secondary pawl lifter rotationally mounted to the secondary pawl pivot, wherein movement of the secondary pawl lifter about the secondary pawl pivot will also cause a corresponding movement of the secondary pawl.

In addition to one or more of the features described above, or as an alternative to any of the foregoing embodiments, the disengagement lever is configured to contact the claw at one end of the disengagement lever and the disengagement lever is configured to contact the secondary pawl lifter at an opposite end of the disengagement lever.

In addition to one or more of the features described above, or as an alternative to any of the foregoing embodiments, the one end of the disengagement lever and the opposite end of the disengagement lever are located on opposite sides of the disengagement lever pivot.

In addition to one or more of the features described above, or as an alternative to any of the foregoing embodiments, the claw pivot, the primary pawl pivot, the secondary pawl pivot, and the disengagement lever pivot are fixedly secured to a frame such that the claw, the primary pawl, the secondary pawl, and the disengagement lever can rotate or pivot with respect to the frame.

In addition to one or more of the features described above, or as an alternative to any of the foregoing embodiments, when the primary pawl is in the disengaged position, the primary pawl does not prevent movement of the claw from the primary position or secondary position.

In addition to one or more of the features described above, or as an alternative to any of the foregoing embodiments, the latching system further including: an actuator operably coupled to the secondary pawl or the disengagement lever.

In addition to one or more of the features described above, or as an alternative to any of the foregoing embodiments, when the secondary pawl is in the engaged position it will prevent the primary pawl from moving from the engaged position towards the disengaged position.

In addition to one or more of the features described above, or as an alternative to any of the foregoing embodiments, the disengagement lever is configured to contact the claw at one end and the disengagement lever is configured to actuate the secondary pawl at an opposite end of the disengagement lever.

Also disclosed is a vehicle latch, including: a latching system, the latching system including: a claw for retaining a striker in a primary position of the claw and a secondary position of the claw, the claw configured for movement about a claw pivot between at least the primary position and the secondary position; a primary pawl configured for movement about a primary pawl pivot between an engaged position and a disengaged position; a secondary pawl configured for movement about a secondary pawl pivot between an engaged position and a disengaged position, the primary pawl and the secondary pawl retaining the claw in the primary position or the secondary position when the primary pawl is in the engaged position and the secondary pawl is in the engaged position; a disengagement lever configured for movement about a disengagement lever pivot, the disengagement lever being operatively coupled to the secondary pawl, wherein when the secondary pawl is in the disengaged position the claw is free to rotate into the primary position from the secondary position and the claw contacts the disengagement lever to maintain the secondary pawl in the disengaged position as the claw rotates into the primary position from the secondary position.

In addition to one or more of the features described above, or as an alternative to any of the foregoing embodiments, the claw pivot, the primary pawl pivot, the secondary pawl pivot, and the disengagement lever pivot are fixedly secured to a frame such that the claw, the primary pawl, the secondary pawl, and the disengagement lever can rotate or pivot with respect to the frame.

In addition to one or more of the features described above, or as an alternative to any of the foregoing embodiments, the vehicle latch further including: a primary pawl lifter rotationally mounted to the primary pawl pivot, wherein movement of the primary pawl lifter about the primary pawl pivot will also cause a corresponding movement of the primary pawl; and a secondary pawl lifter rotationally mounted to the secondary pawl pivot, wherein movement of the secondary pawl lifter about the secondary pawl pivot will also cause a corresponding movement of the secondary pawl.

In addition to one or more of the features described above, or as an alternative to any of the foregoing embodiments, the disengagement lever is configured to contact the claw at one end of the disengagement lever and the disengagement lever is configured to contact the secondary pawl lifter at an opposite end of the disengagement lever.

In addition to one or more of the features described above, or as an alternative to any of the foregoing embodiments, the one end of the disengagement lever and the opposite end of the disengagement lever are located on opposite sides of the disengagement lever pivot.

In addition to one or more of the features described above, or as an alternative to any of the foregoing embodiments, the claw pivot, the primary pawl pivot, the secondary pawl pivot, and the disengagement lever pivot are fixedly secured to a frame such that the claw, the primary pawl, the secondary pawl, and the disengagement lever can rotate or pivot with respect to the frame.

In addition to one or more of the features described above, or as an alternative to any of the foregoing embodiments, when the primary pawl is in the disengaged position, the primary pawl does not prevent movement of the claw from the primary position or secondary position.

In addition to one or more of the features described above, or as an alternative to any of the foregoing embodiments, the vehicle latch further including: an actuator operably coupled to the secondary pawl or the disengagement lever.

In addition to one or more of the features described above, or as an alternative to any of the foregoing embodiments, when the secondary pawl is in the engaged position it will prevent the primary pawl from moving from the engaged position towards the disengaged position.

In addition to one or more of the features described above, or as an alternative to any of the foregoing embodiments, the disengagement lever is configured to contact the claw at one end and the disengagement lever is configured to actuate the secondary pawl at an opposite end of the disengagement lever.

Also disclosed is a method for retaining and releasing a striker of a latching system for a vehicle latch, including: retaining a striker with a claw in a primary position of the claw and a secondary position of the claw, the claw configured for movement about a claw pivot between at least the primary position and the secondary position; rotatably mounting a primary pawl about a primary pawl pivot between an engaged position and a disengaged position; rotatably mounting a secondary pawl about a secondary pawl pivot between an engaged position and a disengaged position, the primary pawl and the secondary pawl retaining the claw in the primary position or the secondary position when the primary pawl is in the engaged position and the secondary pawl is in the engaged position; and rotatably mounting a disengagement lever about a disengagement lever pivot, the disengagement lever being operatively coupled to the secondary pawl, wherein when the secondary pawl is in the disengaged position the claw is free to rotate into the primary position from the secondary position and the claw contacts the disengagement lever to maintain the secondary pawl in the disengaged position as the claw rotates into the primary position from the secondary position.

### BRIEF DESCRIPTION OF THE DRAWINGS

The following descriptions should not be considered limiting in any way. With reference to the accompanying drawings, like elements are numbered alike:

FIG. 1 is a perspective view of a vehicle latch with a latching system according to various embodiments of the present disclosure.

FIG. 2 illustrates the latching system according to various embodiments of the present disclosure;

FIG. 2A is a perspective view of the latching system according to various embodiments of the present disclosure;

FIG. 3 is a view of the latching system according to various embodiments of the present disclosure in a primary or fully latched position;

FIG. 4 is a view of the latching system according to various embodiments of the present disclosure in a secondary or partially latched position;

FIG. 5 is a view of the latching system according to various embodiments of the present disclosure in an open position; and

FIG. 6 is a view of the latching system according to various embodiments of the present disclosure showing disengagement of a secondary pawl by claw rotation and the primary pawl is capable of rotating as the claw rotates into the primary position.

### DETAILED DESCRIPTION

A detailed description of one or more embodiments of the disclosed apparatus and method are presented herein by way of exemplification and not limitation with reference to the Figures.

The present disclosure is directed to a latching system comprising a forkbolt or claw rotating about a fixed pivot, a primary detent or pawl that is able to rotate about a fixed pivot, a secondary detent or pawl that is able to rotate about a fixed pivot, and a disengagement lever configured for actuating the secondary detent or pawl and contacting the forkbolt or claw. The present disclosure provides the benefits of the alternative latch system described above, but is able to move from the secondary or partially latched position to the primary or fully latched position without the addition of more components including those required for disengagement of the primary detent or primary pawl from the forkbolt or claw.

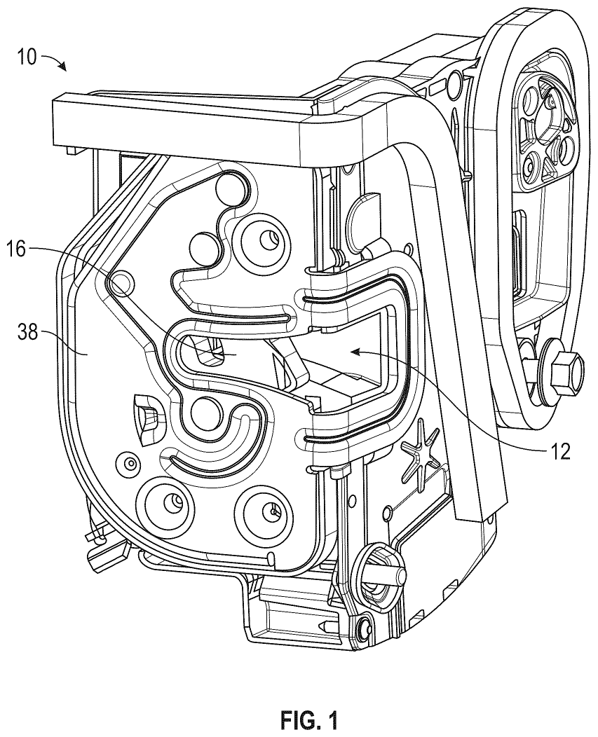

FIG. 1 is a perspective view of a vehicle latch 10 with a latching system 12 according to various embodiments of the present disclosure.

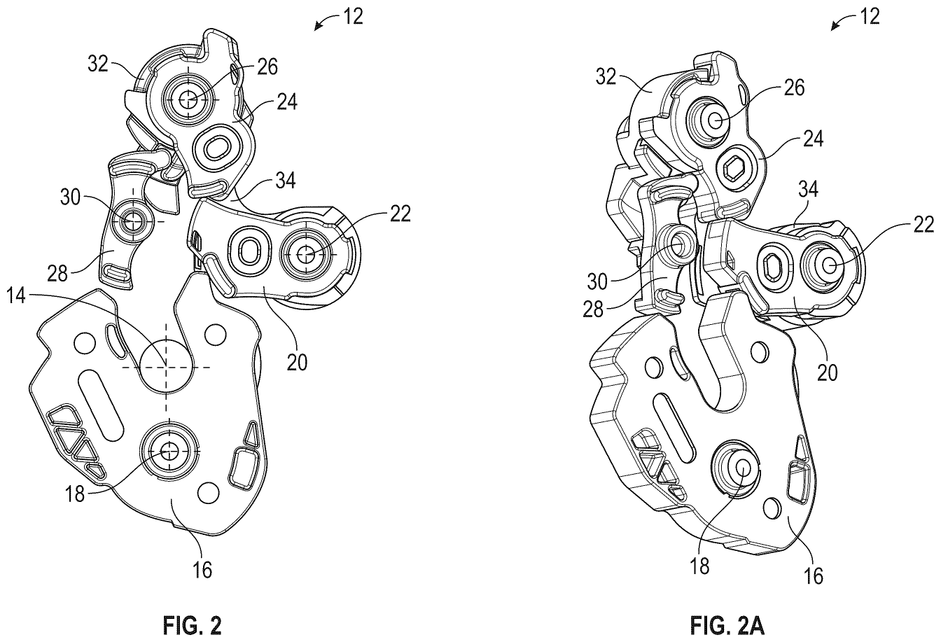

FIG. 2 illustrates the latching system 12 according to various embodiments of the present disclosure.

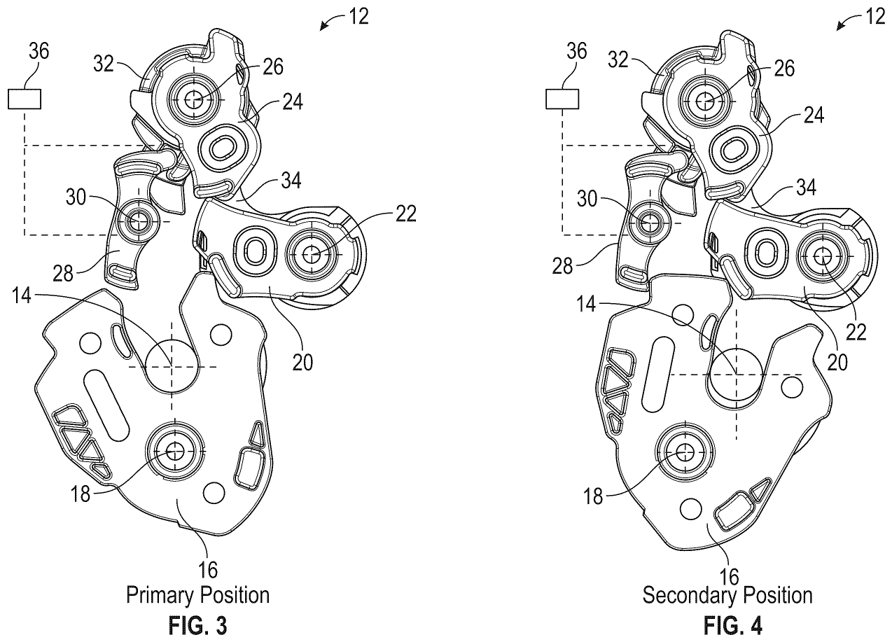

FIG. 3 is a view of the latching system 10 according to various embodiments of the present disclosure in a primary or fully latched position.

FIG. 4 is a view of the latching system 10 according to various embodiments of the present disclosure in a secondary or partially latched position.

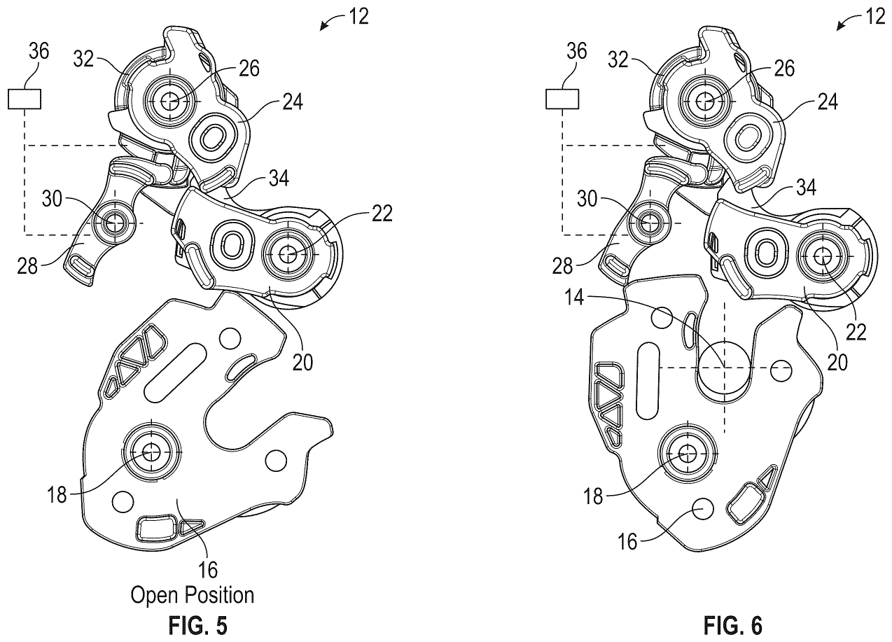

FIG. 5 is a view of the latching system 10 according to various embodiments of the present disclosure in an open position. It being understood that that the secondary or partially latched position of the latching system is between the primary or fully latched position and the open position.

FIG. 6 is a view of the latching system 10 according to various embodiments of the present disclosure showing disengagement of a secondary pawl by claw rotation and the primary pawl is capable of rotating as the claw rotates into the primary position.

Referring now to FIGS. 1-6, the latching system 12 includes at least the following components: a striker 14 to be retained by a forkbolt or claw 16 which rotates about a fixed pivot or forkbolt or claw pivot 18, a primary detent or pawl 20 that rotates around a fixed pivot or primary detent pivot or pawl pivot 22, a secondary detent or pawl 24 which rotates about a fixed pivot or a secondary detent pivot or pawl pivot 26 and a disengagement lever 28 pivotally or rotationally mounted to a disengagement lever pivot 30. The disengagement lever 28 is configured to be contacted by both the claw or forkbolt 16 and a secondary pawl lifter 32 as will be discussed herein. The secondary pawl lifter 32 is also rotationally mounted to the fixed pivot or secondary detent pivot or pawl pivot 26. Movement of the secondary pawl lifter 32 about the fixed pivot or secondary detent pivot or pawl pivot 26 will also cause a corresponding movement of the secondary detent or pawl 24.

Similarly, a primary pawl lifter 34 is also rotationally mounted to the fixed pivot or primary detent pivot or primary pawl pivot 22. Movement of the primary pawl lifter 34 about the fixed pivot or primary detent pivot or primary pawl pivot 22 will also cause a corresponding movement of the primary pawl or primary detent 20.

The primary pawl or primary detent 20 is configured for movement between an engaged position and a disengaged position and the secondary pawl or secondary detent 24 is configured for movement between an engaged position and a disengaged position. The primary pawl or primary detent 20 and the secondary pawl or secondary detent 24 retaining the claw or forkbolt 16 in the primary position or the secondary position when the primary pawl or primary detent 20 is in the engaged position and the secondary pawl or secondary detent 24 is in the engaged position. In accordance with one non-limiting embodiment of the present disclosure, the primary pawl or primary detent 20 and the secondary pawl or secondary detent 24 are spring biased (not shown) to their respective engaged positions.

When the primary pawl or primary detent 20 and the secondary pawl or secondary detent 24 are in their respective engaged positions, the forkbolt or claw 16 is prevented from moving from the primary position to the secondary or open positions and the forkbolt or claw 16 is prevented from moving from the secondary position to the open position however, the configuration of the latching system 12 allows the forkbolt or claw 16 to move from the secondary position to the primary position without the primary pawl or primary detent 20 from preventing this movement. It being understood that that the secondary position of the forkbolt or claw 16 is between the primary and the open positions of the forkbolt or claw 16.

FIG. 3 shows the latching system 12 and the forkbolt or claw 16 in a primary position or fully latched position. In the primary or fully latched position of the forkbolt or claw 16, the primary detent or pawl 20 and the secondary detent or secondary pawl 24 are in an engaged position such that the primary pawl or primary detent 20 makes contact with the forkbolt or claw 16 to prevent its rotation clockwise with respect to the view illustrated in at least FIGS. 2, 3 and 4. As used herein, counterclockwise and clockwise are with respect to the views illustrated in the attached FIGS.

FIG. 4 shows the latching system 12 and the forkbolt or claw 16 in a secondary position or partially latched position. In the secondary position or partially latched position of the forkbolt or claw 16, the primary detent or pawl 20 is still in an engaged position such that it makes contact with the forkbolt or claw 16 to prevent its rotation clockwise with respect to the view illustrated in at least FIG. 4. In addition, the secondary pawl or secondary detent 24 is in the engaged position to prevent movement of the primary pawl or primary detent 20 to the disengaged position.

FIG. 5 shows the latching system 12 in a fully open position. In the fully open position, the striker 14 has been released from the forkbolt or claw 16. In order to release the latching system 12, the disengagement lever 28 has been actuated by an actuator 36 (illustrated schematically) that is operably coupled (illustrated by the dashed lines) to the disengagement lever 28. Actuation of the disengagement lever 28 by the actuator 36 will cause the disengagement lever 28 to rotate clockwise about the disengagement lever pivot 30, which will cause the disengagement lever 28 to contact the secondary pawl lifter 32 and rotate the secondary pawl lifter 32 and the secondary detent or pawl 24 counterclockwise about the fixed pivot or secondary detent pivot or pawl pivot 26 to the disengaged position of the secondary pawl or secondary pivot 24. Movement of the secondary pawl lifter 32 and the secondary pawl or secondary detent 24 about the fixed pivot or secondary detent pivot or pawl pivot 26 will also cause a corresponding clockwise movement of the primary pawl lifter 34 and the primary pawl or primary detent 20 about the fixed pivot or primary detent pivot or primary pawl pivot 22 to its disengaged position, which will allow the claw 16 to rotate into the open position.

Alternatively, the actuator 36 may be operatively coupled to the secondary pawl lifter 32 as opposed to the disengagement lever 28 wherein the actuator 36 can actuate the secondary pawl lifter 32 instead of the disengagement lever 28 to provide the desired movement as the secondary pawl lifter 32 is operably coupled to disengagement lever 28 as well as the secondary pawl or detent 24. This alternative configuration is illustrated by the dashed line from the actuator 36 to the secondary pawl lifter 32. In this embodiment, the actuator 36 is not directly coupled to the disengagement lever 28 as it is directly coupled to the secondary pawl lifter 32.

The configuration of the latching system 12 as disclosed herein allows for release of the latching system 12 though movement of the disengagement lever 28 and the configuration of the disengagement lever 28 also allows the disengagement lever 28 to maintain the secondary pawl or secondary detent 24 in a disengaged position so that the primary pawl or primary detent 20 does not prevent movement of the claw or forkbolt 16 from the secondary position to the primary position.

FIG. 6 illustrates disengagement of the secondary pawl or secondary detent 24 by rotation of the claw or forkbolt 16 counterclockwise from the secondary position. As the claw or forkbolt 16 rotates counterclockwise from the position illustrated in at least FIG. 4 (e.g., from the secondary position), the claw or forkbolt 16 contacts the disengagement lever 28 and causes the disengagement lever 28 to rotate clockwise and at the same time the disengagement lever 28 contacts the secondary pawl lifter 32 and rotates the secondary pawl lifter 32 counterclockwise which in turn moves the secondary pawl or secondary detent 24 counterclockwise to the position illustrated in at least FIG. 6. When the secondary pawl or secondary detent 24 is in the position illustrated in at least FIG. 6, the fokbolt or claw 16 can rotate from the secondary position to the primary position without the primary pawl or primary detent 20 preventing the counterclockwise rotation of the fokbolt or claw 16.

As illustrated, the disengagement lever 28 is configured to contact the claw or forkbolt 16 at one end of the disengagement lever 28 and the disengagement lever 28 is configured to contact the secondary pawl lifter 32 at an opposite or other end of the disengagement lever 28. The one end of the disengagement lever 28 and the opposite end of the disengagement lever 28 are located on opposite sides of the disengagement lever pivot 30. In other words, and in order to release the latching system 10 from a primary latched state or alternatively the secondary position, the disengagement lever 28 is actuated to the position illustrated in FIG. 5. Thereafter, and after removal of the actuation force, the disengagement lever 28 returns to position illustrated in at least FIGS. 3 and 4 due to a spring biasing force (not shown), which may be applied to the secondary pawl lifter 32, which in turn is applied to the disengagement lever 28 by virtue of its contact with the secondary pawl lifter 32. However and during a closing operation, the claw or forkbolt 16 moves from the open position to the secondary position and then to the primary position.

During this movement the claw or forkbolt 16 will contact the disengagement lever 28 and move it to the position illustrated in at least FIG. 5 or 6 (without operation of the actuator 36) in order to ensure the primary pawl or primary detent 20 does not prevent movement of the claw or forkbolt 16 to the primary position.

Accordingly, a double pawl system is provided wherein the forkbolt or claw can rotate from the secondary position to the primary position or fully latched position without the primary pawl or primary detent 20 preventing this movement.

Referring now to FIG. 1, the forkbolt or claw pivot 18, the primary detent pivot or primary pawl pivot 22, and the secondary detent pivot or the secondary pawl pivot 26 are fixedly secured to a frame or backing plate 38, such that the forkbolt or claw 16, the primary detent or primary pawl 20, the secondary detent or secondary pawl 24, and the disengagement lever 28 pivot or rotate with respect to the frame or backing plate 38.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A latching system for a vehicle latch, comprising:
a claw for retaining a striker in a primary position of the claw and a secondary position of the claw, the claw configured for movement about a claw pivot between at least the primary position and the secondary position;
a primary pawl configured for movement about a primary pawl pivot between an engaged position and a disengaged position; and
a secondary pawl configured for movement about a secondary pawl pivot between an engaged position and a disengaged position, the primary pawl and the secondary pawl retaining the claw in the primary position or the secondary position when the primary pawl is in the engaged position and the secondary pawl is in the engaged position;
a disengagement lever configured for movement about a disengagement lever pivot, the disengagement lever being operatively coupled to the secondary pawl, wherein when the secondary pawl is in the disengaged position the claw is free to rotate into the primary position from the secondary position and the claw contacts the disengagement lever to maintain the secondary pawl in the disengaged position as the claw rotates into the primary position from the secondary position.

2. The latching system as in claim 1, further comprising:
a primary pawl lifter rotationally mounted to the primary pawl pivot, wherein movement of the primary pawl lifter about the primary pawl pivot will also cause a corresponding movement of the primary pawl; and
a secondary pawl lifter rotationally mounted to the secondary pawl pivot, wherein movement of the secondary pawl lifter about the secondary pawl pivot will also cause a corresponding movement of the secondary pawl.

3. The latching system as in claim 2, wherein the disengagement lever is configured to contact the claw at one end of the disengagement lever and the disengagement lever is configured to contact the secondary pawl lifter at an opposite end of the disengagement lever.

4. The latching system as in claim 3, wherein the one end of the disengagement lever and the opposite end of the disengagement lever are located on opposite sides of the disengagement lever pivot.

5. The latching system as in claim 4, wherein the claw pivot, the primary pawl pivot, the secondary pawl pivot, and the disengagement lever pivot are fixedly secured to a frame such that the claw, the primary pawl, the secondary pawl, and the disengagement lever can rotate or pivot with respect to the frame.

6. The latching system as in claim 1, wherein when the primary pawl is in the disengaged position, the primary pawl does not prevent movement of the claw from the primary position or secondary position.

7. The latching system as in claim 1, further comprising:
an actuator operably coupled to the secondary pawl or the disengagement lever.

8. The latching system as in claim 1, wherein when the secondary pawl is in the engaged position it will prevent the primary pawl from moving from the engaged position towards the disengaged position.

9. The latching system as in claim 1, wherein the disengagement lever is configured to contact the claw at one end and the disengagement lever is configured to actuate the secondary pawl at an opposite end of the disengagement lever.

10. A vehicle latch, comprising:
a latching system, the latching system including:
a claw for retaining a striker in a primary position of the claw and a secondary position of the claw, the claw configured for movement about a claw pivot between at least the primary position and the secondary position;
a primary pawl configured for movement about a primary pawl pivot between an engaged position and a disengaged position;
a secondary pawl configured for movement about a secondary pawl pivot between an engaged position and a disengaged position, the primary pawl and the secondary pawl retaining the claw in the primary position or the secondary position when the primary pawl is in the engaged position and the secondary pawl is in the engaged position;
a disengagement lever configured for movement about a disengagement lever pivot, the disengagement lever being operatively coupled to the secondary pawl, wherein when the secondary pawl is in the disengaged position the claw is free to rotate into the primary position from the secondary position and the claw contacts the disengagement lever to maintain the secondary pawl in the disengaged position as the claw rotates into the primary position from the secondary position.

11. The vehicle latch as in claim 10, wherein the claw pivot, the primary pawl pivot, the secondary pawl pivot, and the disengagement lever pivot are fixedly secured to a frame such that the claw, the primary pawl, the secondary pawl, and the disengagement lever can rotate or pivot with respect to the frame.

12. The vehicle latch as in claim 10, further comprising:
a primary pawl lifter rotationally mounted to the primary pawl pivot, wherein movement of the primary pawl lifter about the primary pawl pivot will also cause a corresponding movement of the primary pawl; and
a secondary pawl lifter rotationally mounted to the secondary pawl pivot, wherein movement of the secondary pawl lifter about the secondary pawl pivot will also cause a corresponding movement of the secondary pawl.

13. The vehicle latch as in claim 12, wherein the disengagement lever is configured to contact the claw at one end of the disengagement lever and the disengagement lever is configured to contact the secondary pawl lifter at an opposite end of the disengagement lever.

14. The vehicle latch as in claim 13, wherein the one end of the disengagement lever and the opposite end of the disengagement lever are located on opposite sides of the disengagement lever pivot.

15. The vehicle latch as in claim 14, wherein the claw pivot, the primary pawl pivot, the secondary pawl pivot, and the disengagement lever pivot are fixedly secured to a frame such that the claw, the primary pawl, the secondary pawl, and the disengagement lever can rotate or pivot with respect to the frame.

16. The vehicle latch as in claim 10, wherein when the primary pawl is in the disengaged position, the primary pawl does not prevent movement of the claw from the primary position or secondary position.

17. The vehicle latch as in claim 1, further comprising:
an actuator operably coupled to the secondary pawl or the disengagement lever.

18. The vehicle latch as in claim 10, wherein when the secondary pawl is in the engaged position it will prevent the primary pawl from moving from the engaged position towards the disengaged position.

19. The vehicle latch as in claim 10, wherein the disengagement lever is configured to contact the claw at one end and the disengagement lever is configured to actuate the secondary pawl at an opposite end of the disengagement lever.

20. A method for retaining and releasing a striker of a latching system for a vehicle latch, comprising:
retaining a striker with a claw in a primary position of the claw and a secondary position of the claw, the claw configured for movement about a claw pivot between at least the primary position and the secondary position;
rotatably mounting a primary pawl about a primary pawl pivot between an engaged position and a disengaged position;
rotatably mounting a secondary pawl about a secondary pawl pivot between an engaged position and a disengaged position, the primary pawl and the secondary pawl retaining the claw in the primary position or the secondary position when the primary pawl is in the engaged position and the secondary pawl is in the engaged position; and
rotatably mounting a disengagement lever about a disengagement lever pivot, the disengagement lever being operatively coupled to the secondary pawl, wherein when the secondary pawl is in the disengaged position the claw is free to rotate into the primary position from the secondary position and the claw contacts the disengagement lever to maintain the secondary pawl in the disengaged position as the claw rotates into the primary position from the secondary position.
